(19) United States
(12) Patent Application Publication
(10) Pub. No.: US 2019/0103591 A1
(43) Pub. Date: Apr. 4, 2019

(54) SEALED BATTERY AND BATTERY CASE

(71) Applicant: PANASONIC INTELLECTUAL PROPERTY MANAGEMENT CO., LTD., Osaka-shi, Osaka (JP)

(72) Inventor: Yasufumi Funato, Osaka (JP)

(73) Assignee: PANASONIC INTELLECTUAL PROPERTY MANAGEMENT CO., LTD., Osaka-shi, Osaka (JP)

(21) Appl. No.: 16/086,468

(22) PCT Filed: Apr. 7, 2017
(86) PCT No.: PCT/JP2017/014492

§ 371 Date: Sep. 19, 2018

(30) Foreign Application Priority Data
May 27, 2016 (JP) 2016-105846

(51) Int. Cl. H01M 2/08; H01M 10/04

(52) U.S. Cl. CPC H01M 2/08; H01M 10/04

(57) ABSTRACT

A sealed battery includes a metal battery case having a bottom portion and an opening; a metal sealing member that seals the opening of the battery case; and a power generation element housed in the battery case. A side wall of the battery case includes a rising portion from the bottom portion, and a bent portion in an open end side. The open end extends toward the inside of the battery case. A thickness of the side wall of the battery case is 0.2 mm or less.

### TECHNICAL FIELD

The present invention relates to a sealed battery and a battery case used therefor, and particularly relates to improvement of sealing property and appearance.

### BACKGROUND ART

Conventionally, a sealed battery has been used as a power source for electronic devices such as portable devices and information devices. The sealed battery is sealed by crimping a vicinity of an open end of a battery case onto a sealing member via an insulating member. Herein, the battery case is usually obtained by applying drawing, or drawing and ironing to a metal plate so as to form a molded product having a bottom portion and an opening, and then cutting (shearing) the vicinity of the opening of the obtained molded product along the outer periphery thereof. On an open end formed by cutting the vicinity of the opening, burrs are inevitably generated. Burrs to the inside of the battery case (inside burrs) or burrs to the outside of the battery case (outer burrs) are generated depending on the cutting directions. Such inside burrs and outside burrs are known to have an effect on the sealing property of the sealed battery (see PTLs 1 to 3). For example, the inside burrs may damage the insulating member at the time of crimping. Furthermore, when outside burrs are present, the open end may not be able to sufficiently press the insulating member.

### CITATION LIST

### Patent Literature

PTL 1: Japanese Patent Unexamined Publication No. S62-47944

PTL 2: Japanese Patent Examined Publication No. H2-22981

PTL 3: Japanese Patent Unexamined Publication No. 2008-166190

### SUMMARY OF THE INVENTION

Recently, electronic devices have increasingly had more functions and smaller size, and therefore, a power source for driving the electronic devices have been also required to have improved energy density and light weight. Thus, reducing a thickness of a side surface of a battery case has been proposed. However, when an open end of the battery case having a small thickness is crimped, a large number of wrinkles occur in the vicinity of the open end. Such wrinkles in the vicinity of the open end occur particularly at high frequency when the thickness of the side wall of the battery case is 0.2 mm or less. A sealed battery having such wrinkles is poor in the sealing property. Herein, when the side wall is thin, burrs that occur by cutting are reduced. In other words, when a battery case having a thin side wall is used, deterioration of the sealing property of a battery is considered to be affected by wrinkles occurring in the vicinity of the open end. Furthermore, such wrinkles in the vicinity of the open end damage appearance of the battery.

A first aspect of the present disclosure includes a battery case made of metal and having a bottom portion and an opening; a sealing member made of metal and sealing the opening of the battery case; and a power generation element housed in the battery case. A side wall of the battery case includes a rising portion from the bottom portion, and a bent portion in an open end side. The open end extends toward the inside of the battery case. A thickness of the side wall of the battery case is 0.2 mm or less. In a section along the normal line of the bottom portion, an open end Pᵢₙ in an inner peripheral surface side of the side wall is located at an intersection between the inner peripheral surface and a perpendicular line Lp perpendicular to a tangent line to the outer peripheral surface at an open end Pₒᵤₜ in an outer peripheral surface side of the side wall, or the open end Pᵢₙ is located in an extending direction side of the open end from the intersection.

A second aspect of the present disclosure relates to a battery case made of metal and having a bottom portion and an opening, wherein a thickness of a side wall of the battery case is 0.2 mm or less, a length DPᵢₙ from the bottom portion to an open end in an inner peripheral surface side of the side wall is not less than a length DPₒᵤₜ from the bottom portion to an open end in an outer peripheral surface side of the side wall.

According to the present disclosure, since occurrence of wrinkles in the vicinity of the open end is suppressed, it is possible to provide a sealed battery having excellent sealing property and an appearance.

### BRIEF DESCRIPTION OF THE DRAWINGS

FIG. 1 is a longitudinal sectional view schematically showing a battery case that is bent in the vicinity of an open end in accordance with one exemplary embodiment of the present invention.

FIG. 2A is a longitudinal sectional view schematically showing a battery case that is not bent in the vicinity of the open end in accordance with one exemplary embodiment of the present invention.

FIG. 2B is a longitudinal sectional view schematically showing a battery case that is not bent in the vicinity of the open end in accordance with another exemplary embodiment of the present invention.

FIG. 3 is a longitudinal sectional view schematically showing a sealed battery in accordance with one exemplary embodiment of the present invention.

FIG. 4 is a longitudinal sectional view schematically showing a conventional battery case that is not bent in the vicinity of the open end.

### DESCRIPTION OF EMBODIMENTS

A sealed battery of this exemplary embodiment includes a battery case made of metal and having a bottom portion and an opening; a sealing member made of metal and sealing the opening of the battery case; and a power generation element housed in the battery case. A vicinity of the open end of a side wall of the battery case is bent, and the open end extends toward the inner side of the battery case. This bent portion is formed by crimping (caulking) the battery case onto the sealing member via an insulating member in the vicinity of the open end. When the battery case is crimped (caulked) onto the sealing member, the battery is sealed.

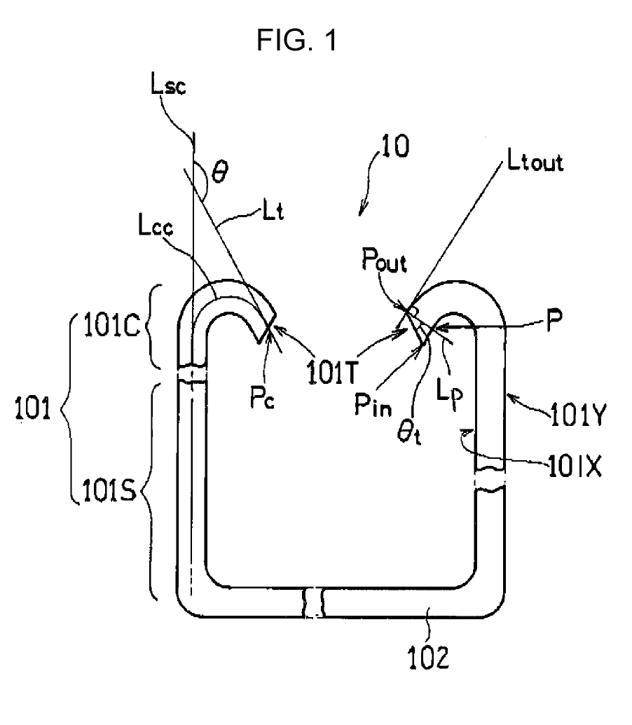

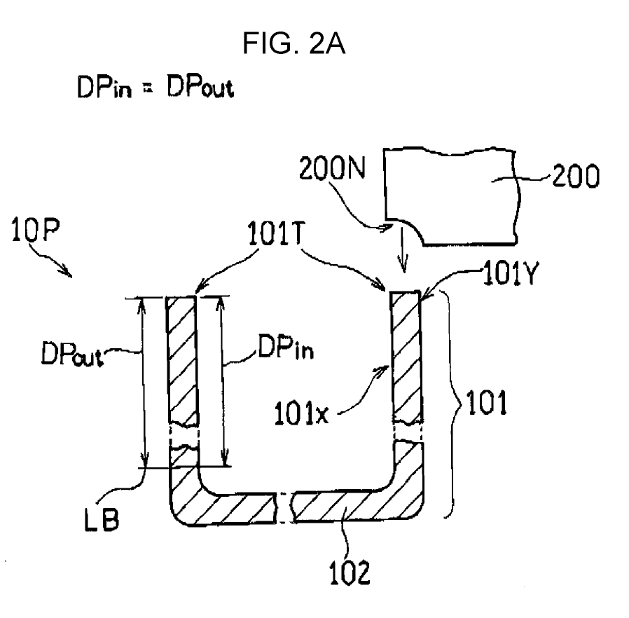

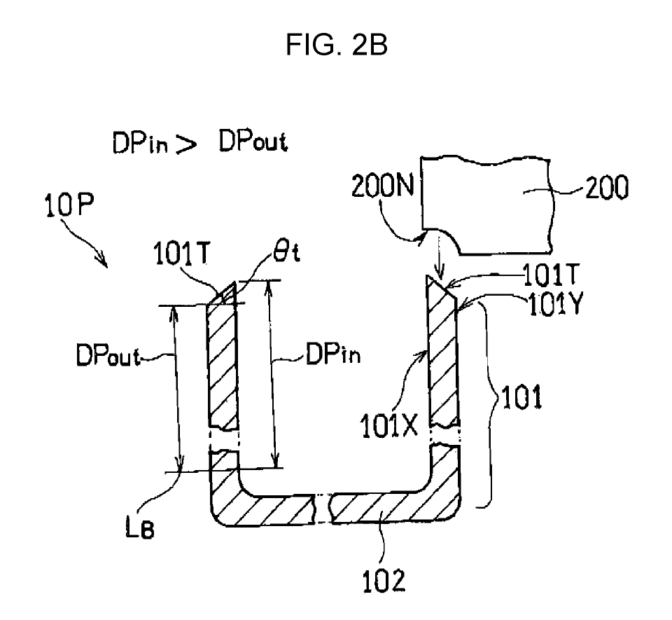

Hereinafter, a structure of a battery case in accordance with this exemplary embodiment is described with reference to FIGS. 1, 2A and 2B. FIG. 1 is a longitudinal sectional view schematically showing a battery case that is bent in the vicinity of an open end in accordance with one exemplary embodiment. FIG. 2A is a longitudinal sectional view schematically showing a battery case that is not bent in the vicinity of the open end in accordance with one exemplary embodiment. FIG. 2B is a longitudinal sectional view schematically showing a battery case that is not bent in the vicinity of the open end in accordance with another exemplary embodiment. FIG. 1 shows only a battery case without showing a power generation element, an insulating member, a sealing member, and the like, for convenience. In the drawings, the same numerals are given to the members having the same functions.

Battery case 10 includes side wall 101 and bottom portion 102. The vicinity of open end 101T of battery case 10 is bent toward the inside of battery case 10 in order to crimp a sealing member. Therefore, side wall 101 has rising portion 101S from bottom portion 102 and bent portion 101C in an open end 101T side. Note here that bent portion 101C corresponds to, for example, a contact region between the below-mentioned crimping jig 200 (see FIG. 2A etc.) and outer peripheral surface 101Y of side wall 101.

In a section along a normal line of bottom portion 102, an open end Pᵢₙ in an inner peripheral surface 101X side of side wall 101 is located at an intersection P between inner peripheral surface 101X and a perpendicular line Lp perpendicular to a tangent line Ltₒᵤₜ to outer peripheral surface 101Y at open end Pₒᵤₜ in an outer peripheral surface 101Y side, or, as shown in FIG. 1, located in an extending direction side of open end 101T of intersection P. In this case, in the vicinity of open end 101T after it is crimped onto a sealing member (not shown), wrinkles having an effect on the sealing property are not observed. This is considered to be because of the following reasons. Note here that when the open end Pᵢₙ and the open end Pₒᵤₜ satisfy the above-mentioned relation, battery case 10P before bending (see FIGS. 2A and 2B), the length DPᵢₙ from bottom portion 102 to the open end Pᵢₙ is not less than the length DPₒᵤₜ from bottom portion 102 to the open end Pₒᵤₜ (DPᵢₙ≥DPₒᵤₜ).

The crimping process is carried out by housing a power generation element in battery case 10P, disposing an insulating member and a sealing member in predetermined positions, and then pressing crimping jig 200 onto open end 101T of battery case 10P as shown in, for example, FIG. 2A, to be pressurized toward bottom portion 102. Crimping jig 200 is provided with cut-away 200N having a curved surface. When crimping jig 200 is pressed down in a state in which open end 101T is in contact with cut-away 200N, the vicinity of open end 101T is deformed such that it is bent along the curved surface of cut-away 200N. Since a diameter of outer peripheral surface 101Y is larger than a diameter of inner peripheral surface 101X, in the vicinity of open end 101T, outer peripheral surface 101Y is deformed while stretching more than inner peripheral surface 101X.

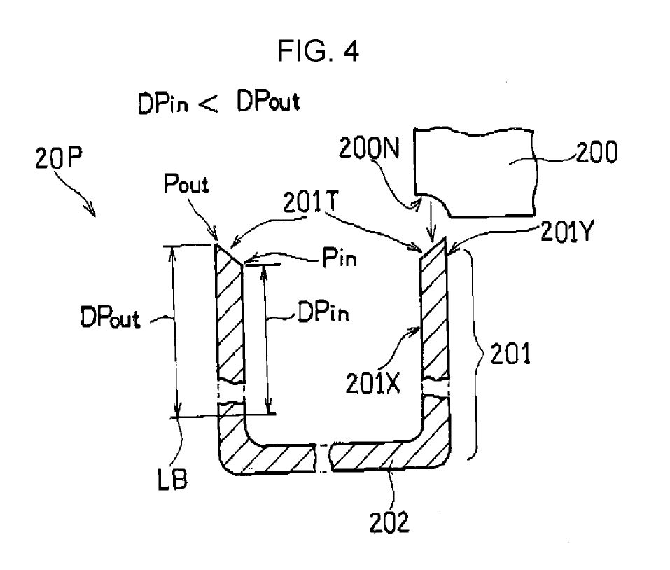

Herein, in a step of manufacturing a battery case, usually, the vicinity of the opening is cut usually by an apparatus provided with a punch and a die (blade). FIG. 4 shows a section of a conventional battery case 20P. Battery case 20P is a battery case in which the vicinity of the opening is cut, and before it is bent. As shown in FIG. 4, open end Pᵢₙ in an inner peripheral surface 201X side of battery case 20P is located nearer to bottom surface 202 than open end Pₒᵤₜ in an outer peripheral surface 201Y side. In the cutting step, for example, by pressing and fixing the die to inner peripheral surface 201X, and by pressing a punch from the outer peripheral surface 201Y side, side wall 201 is cut. At this time, cutting is completed in which shearing of side wall 201 proceeds firstly, and then, side wall 201 is broken. When side wall 201 is broken, since a part of the end part of inner peripheral surface 201X is torn, open end Pᵢₙ in the inner peripheral surface 201X side is nearer to a bottom surface 202 than at open end Pₒᵤₜ in the outer peripheral surface 201Y side. In other words, in battery case 20P, length DPᵢₙ from bottom portion 202 to open end Pᵢₙ is shorter than length DPₒᵤₜ from bottom portion 202 to open end Pₒᵤₜ (DPᵢₙ<DPₒᵤₜ).

When battery case 20P before bending satisfies DPᵢₙ<DPₒᵤₜ, a deformation amount (stretch amount) in the vicinity of open end Pₒᵤₜ is further increased. Furthermore, when DPᵢₙ<DPₒᵤₜ is satisfied, cut-away 200N is brought into contact with the open end Pₒᵤₜ in the outer peripheral surface 201Y side. Then, in a state in which the open end Pₒᵤₜ is in contact with cut-away 200N, the vicinity of open end 201T is bent. When DPᵢₙ<DPₒᵤₜ is satisfied, the vicinity of the open end Pₒᵤₜ has a small thickness. Therefore, due to stress by the crimping process, the vicinity of the open end Pₒᵤₜ is easily deformed. That is to say, since the vicinity of the open end Pₒᵤₜ greatly stretches, and, in addition, easily deformed, a large amount of wrinkles occur in the vicinity of open end 201T.

On the other hand, as shown in FIG. 2A, when side wall 101 of battery case 10P satisfies DPᵢₙ=DPₒᵤₜ, deformation of outer peripheral surface 101Y is suppressed as compared with the case where side wall 101 satisfies DPᵢₙ<DPₒᵤₜ. Furthermore, stress applied to open end 101T in the outer peripheral surface 101Y side is also reduced. Therefore, when the vicinity of open end 101T is bent, occurrence of wrinkles is also suppressed.

As shown in FIG. 2B, battery case 10P satisfies DPᵢₙ>DPₒᵤₜ, as compared with the case where DPᵢₙ<DPₒᵤₜ is satisfied and further DPᵢₙ=DPₒᵤₜ is satisfied, a deformation amount of outer peripheral surface 101Y is small. Furthermore, since open end 101T in the outer peripheral surface 101Y side is not easily brought into contact with cut-away 200N, stress is not easily applied. Thus, even when the vicinity of open end 101T is bent, occurrence of wrinkles is suppressed. When DPᵢₙ>DPₒᵤₜ is satisfied, an effect of suppressing wrinkles is higher than the case where DPᵢₙ=DPₒᵤₜ is satisfied. In this case, a difference between the length Dᵢₙ and length Dₒᵤₜ (DPᵢₙ-DPₒᵤₜ) is not particularly limited, but it is, for example, more than 0 and not more than 200 μm.

The size relation between length DPᵢₙ and length DPₒᵤₜ of battery case 10P, in a longitudinal section of battery case 10P, can be determined as a distance from reference line LB that is horizontally drawn from arbitrary point of side wall 101 to bottom portion 102 to open end 101T. That is to say, a distance from the intersection between reference line LB and inner peripheral surface 101X to open end 101T in the inner peripheral surface 101X side is defined as length DPᵢₙ. Similarly, a distance from the intersection between reference line LB and outer peripheral surface 101Y to open end 101T in the outer peripheral surface 101Y side is defined as length DPₒᵤₜ, and may be compared with the length DPᵢₙ.

An angle θt made by a perpendicular line Lp and open end 101T (see FIG. 1) is not particularly limited, and the angle is, for example, 0 to 60°. From the viewpoint of workability, the angle θt is preferably 1 to 45°.

When DPᵢₙ<DPₒᵤₜ is satisfied, the occurrence of wrinkles is remarkable when a thickness T1 of side wall 101 is 0.2 mm or less, and particularly 0.12 mm or less. This is because when the thickness of side wall 101 is small, the strength of the vicinity of open end 101T is reduced, and stress applied during crimping process is easily increased. However, as shown in FIGS. 2A and 2B, DPᵢₙ≥DPₒᵤₜ (Dᵢₙ≥Dₒᵤₜ) is satisfied, even when the thickness T1 is 0.2 mm or less, an effect of suppressing the occurrence of wrinkles is excellent. The effect of suppressing the occurrence of wrinkles is likely to be observed as the thickness T1 is smaller. However, the thickness T1 is preferably 0.1 mm or more from the viewpoint of strength. The thickness T1 of side wall 101 may be less than 0.18 mm, 0.16 mm or less, and 0.12 mm or less. Note here that the thickness T1 is an average value.

Herein, when the thickness of side wall 101 is not uniform, thickness T1 may be a thickness of bent portion 101C. The thickness of bent portion 101C can be obtained as an average value of lengths between inner peripheral surface 101X and outer peripheral surface 101Y in straight lines perpendicular to tangent lines at arbitrary five points to outer peripheral surface 101Y in bent portion 101C.

Furthermore, when DPᵢₙ<DPₒᵤₜ is satisfied, the occurrence of wrinkles is remarkable as the degree of bending of bent portion 101C is larger. For example, as shown in FIG. 1, when an angle θ is 80° or more, wrinkles easily occur in the vicinity of open end 101T, where the angle θ is an angle which is made by a tangent line Lt to a centerline Lcc of a thickness of bent portion 101C at the intersection Pc between the centerline Lcc and the open end, and a centerline Lsc of a thickness of rising portion 101S, and which is formed outer than the tangent line Lt seen from open end 101T. However, when DPᵢₙ≥DPₒᵤₜ is satisfied, even when the angle θ is 80° or more, an effect of suppressing the occurrence of wrinkles is excellent. Also when the angle θ is 90° or more, and further angle θ is 150° or more, the effect of suppressing the occurrence of wrinkles is obtained. Needless to say, also when the angle θ is less than 80°, the effect of suppressing the occurrence of wrinkles is obtained. Note here that the angle θ is 0° or more and 180° or less.

Thickness T2 of bottom portion 102 of battery case 10 is preferably 0.1 mm or more, and more preferably 0.15 mm or more from the viewpoint of strength and then corrosion-resistance. On the other hand, from the viewpoint of cost and workability, thickness T2 is preferably 0.25 mm or less, and more preferably 0.2 mm or less. Note here that thickness T2 is an average value. The thicknesses T1 and T2 may be different from each other.

Battery case 10 is obtained by subjecting a metal plate to drawing, or drawing and ironing so as to obtain a molded product provided with side wall 101, bottom portion 102, and an opening that faces bottom portion 102, and then cutting (shearing) side wall 101 in the vicinity of the opening of the molded product along the outer periphery thereof. The cutting is carried out by using, for example, a shear apparatus including a punch and a die (blade). At this time, for example, by polishing the cut surface, open end 101T that satisfies DPᵢₙ=DPₒᵤₜ or DPᵢₙ>DPₒᵤₜ is formed. Alternatively, by adjusting a gap (clearance) between the punch and the die (blade) of the shear apparatus or an angle when the die (blade) and side wall 101 are brought into contact with each other, open end 101T that satisfies DPᵢₙ=DPₒᵤₜ or DPᵢₙ>DPₒᵤₜ is formed.

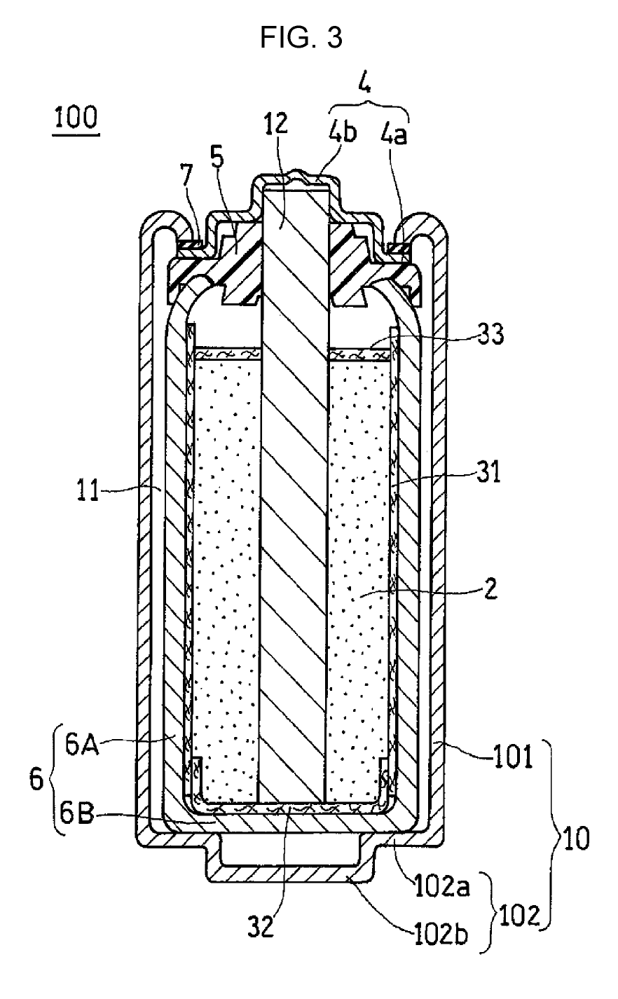

Hereinafter, this exemplary embodiment is described with reference to FIG. 3, taking a case in which battery case 10 is used as an outer can of an AA manganese dry battery as an example. FIG. 3 is a longitudinal sectional view schematically showing a sealed battery in accordance with this exemplary embodiment. Note here that the size, type and structure of the sealed battery are not limited to these alone, primary batteries such as manganese dry batteries other than AA size batteries and lithium batteries, and secondary batteries such as lithium ion batteries and nickel hydrogen chargeable batteries, and the like.

Sealed battery (in this case, manganese dry battery) 100 includes negative electrode can 6, battery case 10 that houses negative electrode can 6, positive electrode material mixture 2 housed in negative electrode can 6, separator 31 and bottom paper 32 provided between positive electrode material mixture 2 and negative electrode can 6, and an electrolytic solution (not shown). Insulation between positive electrode material mixture 2 and negative electrode can 6 is secured by separator 31 and bottom paper 32. Furthermore, an upper end face of positive electrode material mixture 2 is covered with disk-shaped flange paper 33. On outer peripheral surface 101Y of battery case 10, a design of a product (not shown) may be printed. Outer peripheral surface 101Y may be covered with label or tube (not shown) having a design of a product printed thereon.

Material of battery case 10 is not particularly limited as long as it is metal, and examples thereof include tin (tin-plated steel plate).

Negative electrode can 6 is made of, for example, a zinc alloy including a small amount of lead (for example, about 3000 ppm). In AA batteries, the outer diameter of negative electrode can 6 is 12.6 to 14 mm. Negative electrode can 6 is manufactured, for example, by impact molding a disk-like metal pellet, and has an opening. The thickness (average value) of side wall 6A of negative electrode can 6 is, for example, 0.18 to 0.25 mm.

Battery case 10 includes side wall 101 and bottom portion 102. In AA batteries, the outer diameter of side wall 101 of battery case 10 is, for example, 13.2 mm to 14.4 mm. Bottom portion 102 includes ring-shaped edge portion 102a and, terminal portion 102b that is surrounded by edge portion 102a and protrudes toward the outer side from edge portion 102a. Edge portion 102a is in contact with an edge portion of bottom portion 6B of negative electrode can 6. Thus, electrical connection between them is secured, and battery case 10 has the same polarity as that of negative electrode can 6. That is to say, terminal portion 102b functions as a negative electrode terminal. The inner surface of edge portion 102a and outer surface of the edge portion of bottom portion 6B have shapes corresponding to each other, for example, a flat shape such that reliable surface contact becomes possible.

Space 11 is provided between side wall 6A and side wall 101. Thus, even when a pin-hole and the like is formed in negative electrode can 6 due to over-discharge, and an electrolytic solution leaks, the electrolytic solution is prevented from being brought into contact with battery case 10 immediately. Thus, corrosion of side wall 101 is suppressed.

Positive electrode material mixture 2 is molded into a cylindrical shape, carbon rod 12 (positive current collector) as a sintered body of carbon powder is inserted into a hollow of positive electrode material mixture 2.

The opening of negative electrode can 6 is blocked by insulating member 5. Insulating member 5 is made of, for example, polyolefin, and has a through hole in the middle portion thereof. Into the through hole, carbon rod 12 is to be inserted. The middle portion of flange paper 33 is also provided with a hole through which carbon rod 12 is allowed to pass. A contact part between carbon rod 12 and insulating member 5 is coated with a sealing member (not shown) for preventing an electrolytic solution from creeping. Similarly, a contact part between insulating member 5 and negative electrode can 6 is coated with a sealing member. For the sealing member, for example, a liquid polymer including polybutene as a main component is used.

Top parts of insulating member 5 and carbon rod 12 are covered with cap 4 that functions as a positive terminal. Cap 4 is made of metal, for example, tin plate. When the top part of carbon rod 12 is fitted into protruding portion 4b provided in the middle of cap 4, electric connection between cap 4 and carbon rod 12 is secured. The edge portion of cap 4 is provided with flat and ring-shaped flange portion 4a. Insulation ring 7 is mounted on flange portion 4a. The vicinity of open end 101T of battery case 10 (see FIG. 1) is crimped by flange portion 4a via insulation ring 7. Thus, negative electrode can 6 is pressed toward a bottom portion 102 side of battery case 10, and bottom portion 6B of negative electrode can 6 is pressed to bottom portion 102 of battery case 10.

For positive electrode material mixture 2, for example, a mixture of powdery manganese dioxide, powdery conductive agent, and an electrolytic solution is used. As the conductive agent, carbon materials are used. Among them, acetylene black is preferable. The content of manganese dioxide included in the positive electrode material mixture is, for example, 40 to 60% by mass. The median diameter in the particle size distribution on the volume basis of manganese dioxide particles is, for example, 20 to 50 μm. As the electrolytic solution, an aqueous solution of zinc chloride including ammonium chloride is used. The content of zinc chloride in an aqueous solution of zinc chloride is, for example, 27 to 33% by mass.

Examples of materials of separator 31, bottom paper 32, and flange paper 33 include kraft paper. For separator 31, kraft paper having a paste applied thereon is used, and disposed such that the surface having paste thereon faces the negative electrode can. Examples of the paste include cross-linked starch and polyvinyl acetate. Bottom paper 32 is formed by punching kraft paper into a circular shape, and then carrying out drawing into a cup shape. Flange paper 33 is obtained by punching the kraft paper into a circular shape.

Hereinafter, Examples of the present invention are described specifically, but the present invention is not limited to these Examples alone.

### Examples 1 to 5

An AA size manganese dry battery (R6) shown in FIG. 3 was produced by the following procedures.

Procedure 1: Preparation of Battery Case

After a tin plate was subjected to deep drawing, using a shear apparatus provided with a punch and a die (blade), the die (blade) is pressed onto the side wall of the battery case from the normal line direction of the side wall, and the vicinity of the opening was cut along the outer periphery thereof. Then, the cut surface was polished to form an open end that satisfies DPᵢₙ=DPₒᵤₜ. The obtained battery case had thickness T1 of 0.2 mm, thickness T2 of 0.2 mm, and an outer diameter of the side wall of 13.9 mm.

Procedure 2: Preparation of Power Generation Element

In a bottomed cylindrical negative electrode can (outer diameter: 13.1 mm, and thickness of the side part: 0.24 mm) made of zinc alloy including 3000 ppm of lead, 8.6 g of cylindrical positive electrode material mixture was housed. At this time, a separator was disposed between the positive electrode material mixture and the negative electrode can. For the separator, kraft paper with paste applied thereon was used. As the paste, cross-linked starch and polyvinyl acetate, which were dissolved in water, were applied on the kraft paper and dried. A face of the separator, on which the paste was applied, was allowed to face the negative electrode can. Between the bottom portion of the positive electrode material mixture and the negative electrode can, kraft paper having a thickness of 0.5 mm was disposed as a bottom paper. On the upper end face of the positive electrode material mixture, annular kraft paper having a thickness of 0.5 mm was disposed as a flange paper.

For the positive electrode material mixture, a mixture of 50.4 parts by mass of manganese dioxide, 8.4 parts by mass of acetylene black, 40.4 parts by mass of electrolytic solution, and 0.8 parts by mass of zinc oxide was used. For the electrolytic solution, a mixture of 30 parts by mass of zinc chloride, 1 part by mass of ammonium chloride, and 69 parts by mass of water was used.

An insulating member made of polyethylene and having a through hole having a diameter of 4 mm in the middle portion thereof, was prepared. A carbon rod having a diameter of 4 mm obtained by sintering carbon powder was allowed to penetrate through the through hole. When the carbon rod was fitted into the through hole of the insulating member, a sealing material was applied to a contact part between the insulating member and the carbon rod. Thereafter, the carbon rod was inserted into a hollow of the positive electrode material mixture, and the opening of the negative electrode can was blocked by the insulating member.

Meanwhile, a cap made of tin, and including a protruding portion in the middle, and a flat flange portion in the periphery thereof was prepared. The cap was produced by carrying out press working of a tin plate having a thickness of 0.22 mm. A top part of the carbon rod was fitted into the inside of the protruding portion of the cap, and an insulation ring made of resin having a thickness of 0.5 mm was disposed in the flange portion. Thereafter, the negative electrode can was housed in the battery case.

Procedure 3: Sealing of Battery

An open end of the battery case housing a negative electrode can was curled inward to be crimped to an insulation ring. At this time, the angle θ was adjusted so as to be 50°, 80°, 120°, 150°, and 180°, respectively.

### Examples 6 to 10

Manganese dry batteries having angle θ of 50°, 80°, 120°, 150°, and 180°, respectively, were obtained in the same manner as in Examples 1 to 5 except that a battery case having T1 of 0.18 mm, and T2 of 0.2 mm was used.

### Examples 11 to 15

Manganese dry batteries having angle θ of 50°, 80°, 120°, 150°, and 180°, respectively, were obtained in the same manner as in Examples 1 to 5 except that a battery case having T1 of 0.15 mm, and T2 of 0.2 mm was used.

### Examples 16 to 20

Manganese dry batteries having angle θ of 50°, 80°, 120°, 150°, and 180°, respectively, were obtained in the same manner as in Examples 1 to 5 except that a battery case having T1 of 0.12 mm, and T2 of 0.2 mm was used.

### Examples 21 to 25

Manganese dry batteries having angle θ of 50°, 80°, 120°, 150°, and 180°, respectively, were obtained in the same manner as in Examples 1 to 5 except that a battery case having T1 of 0.10 mm, and T2 of 0.2 mm was used.

### Examples 26 to 30

Manganese dry batteries having angle θ of 50°, 80°, 120°, 150°, and 180°, respectively, were obtained in the same manner as in Examples 1 to 5 except that by adjusting a contact angle between a punch of a press processing machine and side wall 101 when the vicinity of the opening was cut in procedure 1, an open end (θt=45°) that satisfies DPᵢₙ>DPₒᵤₜ (DPᵢₙ−DPₒᵤₜ=200 μm) was formed in the battery case.

### Examples 31 to 35

Manganese dry batteries having angle θ of 50°, 80°, 120°, 150°, and 180°, respectively, were obtained in the same manner as in Examples 6 to 10 except that by adjusting a contact angle between a punch of a press processing machine and side wall 101 when the vicinity of the opening was cut in procedure 1, an open end (θt=45°) that satisfies DPᵢₙ>DPₒᵤₜ was formed in the battery case.

### Examples 36 to 40

Manganese dry batteries having angle θ of 50°, 80°, 120°, 150°, and 180°, respectively, were obtained in the same manner as in Examples 11 to 15 except that by adjusting a contact angle between a punch of a press processing machine and side wall 101 when the vicinity of the opening was cut in procedure 1, an open end (θt=45°) that satisfies DPᵢₙ>DPₒᵤₜ was formed in the battery case.

### Examples 41 to 45

Manganese dry batteries having angle θ of 50°, 80°, 120°, 150°, and 180°, respectively, were obtained in the same manner as in Examples 16 to 20 except that by adjusting a contact angle between a punch of a press processing machine and side wall 101 when the vicinity of the opening was cut in procedure 1, an open end (θt=45°) that satisfies DPᵢₙ>DPₒᵤₜ was formed in the battery case.

### Examples 46 to 50

Manganese dry batteries having angle θ of 50°, 80°, 120°, 150°, and 180°, respectively, were obtained in the same manner as in Examples 21 to 25 except that by adjusting a contact angle between a punch of a press processing machine and side wall 101 when the vicinity of the opening was cut in procedure 1, an open end (θt=45°) that satisfies DPᵢₙ>DPₒᵤₜ was formed in the battery case.

### Comparative Examples 1 to 5

Manganese dry batteries having angle θ of 50°, 80°, 120°, 150°, and 180°, respectively, were obtained in the same manner as in Examples 1 to 5 except that in procedure 1, the cut surface was not polished after the vicinity of the opening was cut. The obtained battery cases had an open end (θt=) 45° that satisfied DPᵢₙ<DPₒᵤₜ.

### Comparative Examples 6 to 10

Manganese dry batteries having angle θ of 50°, 80°, 120°, 150°, and 180°, respectively, were obtained in the same manner as in Examples 6 to 10 except that in procedure 1, the cut surface was not polished after the vicinity of the opening was cut. The obtained battery cases had an open end (θt=45°) that satisfied DPᵢₙ<DPₒᵤₜ.

### Comparative Examples 11 to 15

Manganese dry batteries having angle θ of 50°, 80°, 120°, 150°, and 180°, respectively, were obtained in the same manner as in Examples 11 to 15 except that in procedure 1, the cut surface was not polished after the vicinity of the opening was cut. The obtained battery cases had an open end (θt=45°) that satisfied DPᵢₙ<DPₒᵤₜ.

### Comparative Examples 16 to 20

Manganese dry batteries having angle θ of 50°, 80°, 120°, 150°, and 180°, respectively, were obtained in the same manner as in Examples 16 to 20 except that in procedure 1, the cut surface was not polished after the vicinity of the opening was cut. The obtained battery cases had an open end (θt=45°) that satisfied DPᵢₙ<DPₒᵤₜ.

### Comparative Examples 21 to 25

Manganese dry batteries having angle θ of 50°, 80°, 120°, 150°, and 180°, respectively, were obtained in the same manner as in Examples 21 to 25 except that in procedure 1, the cut surface was not polished after the vicinity of the opening was cut. The obtained battery cases had an open end (θt=45°) that satisfied DPᵢₙ<DPₒᵤₜ.

### Comparative Examples 26 to 30

Manganese dry batteries having angle θ of 50°, 80°, 120°, 150°, and 180°, respectively, were obtained in the same manner as in Examples 1 to 5 except that in procedure 1, the cut surface was not polished after the vicinity of the opening was cut, and T1 was 0.25 mm and thickness T2 was 0.25 mm. The obtained battery cases had an open end (θt=45°) that satisfied DPᵢₙ<DPₒᵤₜ.

### Comparative Examples 31 to 35

Manganese dry batteries having angle θ of 50°, 80°, 120°, 150°, and 180°, respectively, were obtained in the same manner as in Examples 1 to 5 except that in procedure 1, the cut surface was not polished after the vicinity of the opening was cut, and T1 was 0.22 mm and thickness T2 was 0.25 mm. The obtained battery cases had an open end (θt=45°) that satisfied DPᵢₙ<DPₒᵤₜ.

### Reference Examples 1 to 5

Manganese dry batteries having angle θ of 50°, 80°, 120°, 150°, and 180°, respectively, were obtained in the same manner as in Examples 1 to 5 except that a battery case having thickness T1 of 0.25 mm, and thickness T2 of 0.25 mm was used.

### Reference Examples 6 to 10

Manganese dry batteries having angle θ of 50°, 80°, 120°, 150°, and 180°, respectively, were obtained in the same manner as in Examples 1 to 5 except that a battery case having thickness T1 of 0.22 mm, and thickness T2 of 0.25 mm was used.

### Reference Examples 11 to 15

Manganese dry batteries having angle θ of 50°, 80°, 120°, 150°, and 180°, respectively, were obtained in the same manner as in Examples 26 to 30 except that a battery case having T1 of 0.25 mm, and T2 of 0.25 mm was used. The obtained battery cases had an open end (θt=45°) that satisfied DPᵢₙ<DPₒᵤₜ.

### Reference Examples 16 to 20

Manganese dry batteries having angle θ of 50°, 80°, 120°, 150°, and 180°, respectively, were obtained in the same manner as in Examples 26 to 30 except that a battery case having T1 of 0.22 mm, and T2 of 0.25 mm was used. The obtained battery cases had an open end (θt=45°) that satisfied DPᵢₙ<DPₒᵤₜ.

Evaluation

(1) Occurrence of Wrinkles

Thirty each of batteries immediately after completion of Examples, Comparative Examples, and Reference Examples were checked for presence or absence of wrinkles in the open end of each battery case by visual observation. The number of dry batteries in which wrinkles were observed was counted. Results are shown in Table 1.

TABLE 1

| | | T1(mm) | | | | | | |
|---|---|---|---|---|---|---|---|---|
| | | Ref. Ex. | Ref. Ex. | Ex. | Ex. | Ex. | Ex. | Ex. |
| | | 1-5 | 6-10 | 1-5 | 6-10 | 11-15 | 16-20 | 21-25 |
| | θ(°) | 0.25 | 0.22 | 0.20 | 0.18 | 0.15 | 0.12 | 0.10 |
| DPin = | 50 | 0 | 0 | 0 | 0 | 0 | 0 | 0 |
| DPout | 80 | 0 | 0 | 0 | 0 | 0 | 0 | 0 |
| | 120 | 0 | 0 | 0 | 0 | 0 | 0 | 0 |
| | 150 | 0 | 0 | 0 | 0 | 0 | 0 | 0 |
| | 180 | 0 | 0 | 0 | 0 | 0 | 0 | 0 |
| | | Ref. Ex. | Ref. Ex. | Ex. | Ex. | Ex. | Ex. | Ex. |
| | | 11-15 | 16-20 | 26-30 | 31-35 | 36-40 | 41-45 | 46-50 |
| DPin > | 50 | 0 | 0 | 0 | 0 | 0 | 0 | 0 |
| DPout | 80 | 0 | 0 | 0 | 0 | 0 | 0 | 0 |
| | 120 | 0 | 0 | 0 | 0 | 0 | 0 | 0 |
| | 150 | 0 | 0 | 0 | 0 | 0 | 0 | 0 |
| | 180 | 0 | 0 | 0 | 0 | 0 | 0 | 0 |

| | | Co. | Co. | Co. | Co. | Co. | Co. | Co. |
|---|---|---|---|---|---|---|---|---|
| | | Ex. | Ex. | Ex. | Ex. | Ex. | Ex. | Ex. |
| | | 26-30 | 31-35 | 1-5 | 6-10 | 11-15 | 16-20 | 21-25 |
| DPin < | 50 | 0 | 0 | 0 | 0 | 0 | 0 | 0 |
| DPout | 80 | 0 | 0 | 1 | 2 | 5 | 13 | 17 |
| | 120 | 0 | 0 | 2 | 3 | 7 | 12 | 17 |
| | 150 | 0 | 0 | 2 | 3 | 8 | 15 | 19 |
| | 180 | 0 | 0 | 2 | 4 | 8 | 17 | 20 |

Ref. Ex. = Reference Example
Co. Ex. = Comparative Example
Ex. = Example

(2) Leakage Resistance

Thirty each of batteries immediately after completion of Examples, Comparative Examples, and Reference Examples were subjected to continuous discharge in an environment of temperature of 30° C. and humidity of 90%, with constant resistance of 3.9Ω and 43Ω for 30 days to make an over-discharge state. Thereafter, presence or absence of occurrence of corrosion on the side wall of the battery case was checked. The number of dry batteries in which corrosion was observed by visual observation was counted. Results are shown in Table 2.

TABLE 2

| | | T1 (mm) | | | | | | |
|---|---|---|---|---|---|---|---|---|
| | | Ref. Ex. | Ref. Ex. | Ex. | Ex. | Ex. | Ex. | Ex. |
| | | 1-5 | 6-10 | 1-5 | 6-10 | 11-15 | 16-20 | 21-25 |
| | θ(°) | 0.25 | 0.22 | 0.20 | 0.18 | 0.15 | 0.12 | 0.10 |
| DPin = | 50 | 0 | 0 | 0 | 0 | 0 | 0 | 0 |
| DPout | 80 | 0 | 0 | 0 | 0 | 0 | 0 | 0 |
| | 120 | 0 | 0 | 0 | 0 | 0 | 0 | 0 |
| | 150 | 0 | 0 | 0 | 0 | 0 | 0 | 0 |
| | 180 | 0 | 0 | 0 | 0 | 0 | 0 | 0 |
| | | Ref. Ex. | Ref. Ex. | Ex. | Ex. | Ex. | Ex. | Ex. |
| | | 11-15 | 16-20 | 26-30 | 31-35 | 36-40 | 41-45 | 46-50 |
| DPin > | 50 | 0 | 0 | 0 | 0 | 0 | 0 | 0 |
| DPout | 80 | 0 | 0 | 0 | 0 | 0 | 0 | 0 |
| | 120 | 0 | 0 | 0 | 0 | 0 | 0 | 0 |
| | 150 | 0 | 0 | 0 | 0 | 0 | 0 | 0 |
| | 180 | 0 | 0 | 0 | 0 | 0 | 0 | 0 |

| | | Co. | Co. | Co. | Co. | Co. | Co. | Co. |
|---|---|---|---|---|---|---|---|---|
| | | Ex. | Ex. | Ex. | Ex. | Ex. | Ex. | Ex. |
| | | 26-30 | 31-35 | 1-5 | 6-10 | 11-15 | 16-20 | 21-25 |
| DPin < | 50 | 0 | 0 | 0 | 0 | 0 | 0 | 0 |
| DPout | 80 | 0 | 0 | 1 | 1 | 3 | 9 | 12 |
| | 120 | 0 | 0 | 1 | 1 | 4 | 8 | 11 |
| | 150 | 0 | 0 | 1 | 2 | 4 | 10 | 11 |
| | 180 | 0 | 0 | 2 | 2 | 5 | 10 | 12 |

Ref. Ex. = Reference Example
Co. Ex. = Comparative Example
Ex. = Example

As can be seen from Comparative Examples 1 to 25, when the thickness T1 was 0.2 mm or less, occurrence of wrinkles was observed in the open end, and leakage of the electrolytic solution is observed. On the other hand, in Examples 1 to 50 in which Dᵢₙ≥Dₒᵤₜ is satisfied, occurrence of wrinkles was not observed in the open end, and leakage of the electrolytic solution was not observed. As can be seen from Comparative Examples 26 to 35 and Reference Examples 1 to 20, when the thickness T1 of the side wall is more than 0.2 mm, regardless of the size relation between the length Dᵢₙ and length Dₒᵤₜ, the occurrence of wrinkles was not observed.

### INDUSTRIAL APPLICABILITY

A sealed battery of the present invention is excellent in sealing property and appearance, and therefore is useful as a power source for various electronic devices. Furthermore, the sealed battery of the present invention can be applied to primary batteries such as a manganese dry battery and alkaline dry battery, and secondary batteries such as a lithium ion battery, a nickel hydrogen battery.

A battery case of the present invention can be applied to outer cans, positive electrode cans or negative electrode cans of primary batteries such as a manganese dry battery and alkaline dry battery, and secondary batteries such as a lithium ion battery, a nickel hydrogen battery.

### REFERENCE MARKS IN THE DRAWINGS

100: sealed battery
2: positive electrode material mixture
31: separator
32: bottom paper
33: flange paper
4: cap
4a: flange portion
4b: protruding portion
5: insulating member
6: negative electrode can
6A: side wall of negative electrode can
6B: bottom portion of negative electrode can
7: insulation ring
10: battery case
10P: battery case before bending
101: side wall
101C: bent portion
101S: rising portion
101T: open end
101X: inner peripheral surface
101Y: outer peripheral surface
102: bottom portion
102a: edge portion
102b: terminal portion
11: space
12: carbon rod
200: crimping jig
200N: cut-away
20P: conventional battery case before bending
201X: inner peripheral surface
201Y: outer peripheral surface
201T: open end

1. A sealed battery comprising:
a battery case made of metal and having a bottom portion and an opening;
a sealing member made of metal and sealing the opening of the battery case; and
a power generation element housed in the battery case;
wherein a side wall of the battery case includes a rising portion from the bottom portion, and a bent portion in an open end face side,
the open end face extends toward an inside of the battery case,
a thickness of the side wall of the battery case is 0.2 mm or less,
in a section along a normal line of the bottom portion, an open end Pᵢₙ in an inner peripheral surface side of the side wall is located at an intersection between the inner peripheral surface and a perpendicular line Lp perpendicular to a tangent line to the outer peripheral surface at an open end Pₒᵤₜ in an outer peripheral surface side of the side wall, or the open end Pᵢₙ is located in an extending direction side of the open end from the intersection.

2. The sealed battery according to claim 1, wherein an angle θ is 80° or more,
where the angle θ is an angle,
made by,
a tangent line Lt to a centerline Lcc of a thickness of the bent portion at an intersection between the centerline Lcc and the open end face, and
a centerline Lsc of a thickness of the rising portion, and
formed outer than the tangent line Lt seen from the open end face.

3. The sealed battery according to claim 2, wherein the angle θ is 120° or more.

4. The sealed battery according to claim 1, wherein the battery case is an outer can having a design printed.

5. The sealed battery according to claim 1, wherein the sealed battery is a manganese dry battery.

6. A battery case,
comprising a bottom portion and an opening, wherein the battery case is made of metal,
a thickness of a side wall of the battery case is 0.2 mm or less,
a length DPᵢₙ from the bottom portion to an open end in an inner peripheral surface side of the side wall is not less than a length DPₒᵤₜ from the bottom portion to an open end in an outer peripheral surface side of the side wall.
